(19) United States
(12) Patent Application Publication
(10) Pub. No.: US 2024/0181929 A1
(43) Pub. Date: Jun. 6, 2024

(54) METHOD OF CONTROLLING DISCHARGE OF BATTERY IN VEHICLE

(71) Applicants: HYUNDAI MOTOR COMPANY, Seoul (KR); KIA CORPORATION, Seoul (KR)

(72) Inventor: Soo Yang Jin, Hwaseong-si (KR)

(73) Assignees: HYUNDAI MOTOR COMPANY, Seoul (KR); KIA CORPORATION, Seoul (KR)

(21) Appl. No.: 18/238,156

(22) Filed: Aug. 25, 2023

(30) Foreign Application Priority Data
Dec. 6, 2022 (KR) 10-2022-0168571

(51) Int. Cl. B60L 58/22; B60L 58/13; H02J 7/34

(52) U.S. Cl. CPC B60L 58/22; B60L 58/13; H02J 7/342; B60L 2240/545

(57) ABSTRACT

In a method of controlling discharge of a battery in a vehicle that generates driving power using electric power to prevent deterioration of the durability of the battery and ensure the stability of the battery, a controller is configured to monitor the state of charge (SOC) value of a first battery configured to supply the electric power to a driving unit of the vehicle and an SOC value and a temperature of a second battery configured to charge the first battery. When the SOC value of the first battery reaches a predetermined first SOC value, the controller is configured to discharge the second battery and charges the first battery in response to the discharging of the second battery. When the SOC value of the second battery reaches the first SOC value, the controller ends the discharging of the second battery.

### CROSS REFERENCE TO RELATED APPLICATION

The present application claims priority to Korean Patent Application No. 10-2022-0168571, filed Dec. 6, 2022, the entire contents of which is incorporated herein for all purposes by this reference.

### BACKGROUND OF THE PRESENT DISCLOSURE

### Field of the Present Disclosure

The present disclosure relates generally to a method of controlling discharge of a battery in a vehicle, and more particularly, to a method of controlling discharge of a battery in a vehicle to prevent deterioration of the durability of the battery and ensure the stability of the battery.

### Description of Related Art

Generally, vehicles that generate driving force from electrical energy are provided with a battery that stores and supplies electrical energy.

An electric vehicle includes a vehicle driving motor generating driving force, a main battery providing driving power, and an auxiliary battery providing electric power to electrical components in the vehicle.

The auxiliary battery is implemented as a secondary battery which may be charged and discharged, and is charged using the main battery as required.

However, durability management for auxiliary batteries has not been separately performed generally, and thus the durability of auxiliary batteries may be reduced.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of controlling discharge of a battery in a vehicle to prevent deterioration of the durability of an auxiliary battery and ensure the stability of the auxiliary battery.

The objective of the present disclosure is not limited to the aforementioned description, and other objectives not explicitly included herein will be clearly understood by those skilled in the art from the description provided hereinafter.

To achieve at least one of the above objectives, according to one aspect of the present disclosure, there is provided a method of controlling discharge of a battery in a vehicle that generates driving power using electric power. The method may include: monitoring, by a controller, a state of charge (SOC) value of a first battery configured to supply the electric power to a driving unit of the vehicle and an SOC value and a temperature of a second battery configured to charge the first battery: when the SOC value of the first battery reaches a predetermined first SOC value, discharging the second battery and charging the first battery by discharging the second battery by the controller; and when the SOC value of the second battery reaches the first SOC value, ending the discharging of the second battery by the controller.

According to an exemplary embodiment of the present disclosure, the SOC value of the first battery is higher than the first SOC value, the second battery may not be discharged.

When the SOC value of the first battery is equal to or lower than the first SOC value and the SOC value of the second battery is equal to or greater than a second SOC value determined to be higher than the first SOC value, the second battery may be discharged.

When the SOC value of the first battery is equal to or lower than the first SOC value and the SOC value of the second battery is lower than the second SOC value, the second battery may not be discharged.

When the SOC value of the first battery is equal to or lower than a third SOC value determined to be lower than the first SOC value, the first battery may be charged by discharging the second battery irrespective of the SOC value of the second battery.

The second battery may be discharged in an output condition determined according to the SOC value and the temperature of the second battery.

The method may further include: counting a non-operating time in which the second battery is nether discharged nor charged when the SOC value of the second battery is equal to or greater than the second SOC value and the second battery is nether discharged nor charged: and determining whether to discharge the second battery according to the non-operating time of the second battery and an average temperature of the second battery during the non-operating time.

When the non-operating time of the second battery is equal to or greater than a predetermined first time and the average temperature of the second battery is equal to or greater than a predetermined threshold temperature, the second battery may be discharged until the SOC value of the second battery reaches the first SOC value.

When the non-operating time of the second battery is equal to or greater than a second time determined to be greater than the first time, the second battery may be discharged until the SOC value of the second battery reaches the first SOC value irrespective of the average temperature of the second battery.

According to an exemplary embodiment of the present disclosure, the following effects are provided.

First, the SOC range in which the second battery is discharged and the frequency of discharge of the second battery may be optimized and thus the durability of the second battery may be obtained, preventing a decrease in the lifetime of the second battery.

Second, it is possible to prevent the second battery from being neglected without being used in a high SOC condition for an extended time, preventing a decrease in the durability of the second battery caused by the second battery being not used in the high SOC condition for the extended time and obtaining the stability of the second battery.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating a configuration of a system for performing a method of controlling discharge of a battery in a vehicle according to various exemplary embodiments of the present disclosure:

FIG. 2 is a flowchart illustrating a method of controlling discharge of an auxiliary battery while driving according to various exemplary embodiments of the present disclosure: and

FIG. 3 is a flowchart illustrating a method of controlling discharge of an auxiliary battery when the auxiliary battery is not working according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION OF THE PRESENT DISCLOSURE

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Specific structural and functional descriptions of embodiments of the present disclosure included herein are only for illustrative purposes of the exemplary embodiments of the present disclosure. The present disclosure may be embodied in various forms without departing from the spirit and significant characteristics of the present disclosure.

It will be understood that terms “comprise”, “include”, “have”, and any variations thereof used herein are intended to cover non-exclusive inclusions unless explicitly described to the contrary.

Furthermore, it will be understood a term such as “module” used herein refers to a unit of processing at least one function or operation. The module may be implemented as a software module running on a predetermined program, a hardware module comprised of electronic devices, or a combination of the software module and the hardware module.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

Hereinafter, various embodiments of the present disclosure will be described with reference to the accompanying drawings. Features illustrated in the drawings are diagrammed to provide a better understanding of embodiments of the present disclosure and may be different from actual implementations.

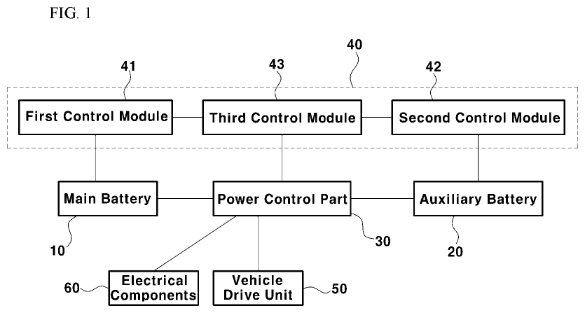

In the accompanying drawings, FIG. 1 illustrates a configuration of a battery control system, i.e., a system for performing a method of controlling discharge of a battery in a vehicle, according to various exemplary embodiments of the present disclosure.

As illustrated in FIG. 1, the battery control system according to various exemplary embodiments of the present disclosure includes a main battery 10, an auxiliary battery 20, a power control portion 30, a controller 40, and the like.

The main battery 10 is a secondary battery which may be charged and discharged, and is connected to a vehicle drive unit 50 to supply power to drive the vehicle drive unit 50. The main battery 10 is connected to the vehicle drive unit 50 through the power control portion 30. The main battery 10 may also supply power to electrical components 60 in the vehicle. The main battery 10 may be referred to as a “first battery”.

The vehicle drive unit 50 includes a vehicle driving motor configured for generating driving force to drive the vehicle. The vehicle drive unit 50 and the vehicle drive unit 50 may be referred to as a “power consuming part”. That is, the power consuming portion includes the vehicle drive unit 50 and the electrical components 60.

The auxiliary battery 20 is a secondary battery which may be charged and discharged, and provides power to drive the vehicle together with the main battery 10. The auxiliary battery 20 is connected to the main battery 10 through the power control portion 30, and outputs discharge power to charge the main battery 10. In the case of discharge, the auxiliary battery 20 may charge the main battery 10 by providing discharge power to the main battery 10 through the power control portion 30, and increase the driving range of the vehicle by charging the main battery 10. The auxiliary battery 20 may be referred to as a “second battery”. The degree of deterioration and durability of the auxiliary battery 20 may vary depending on the state of charge (SOC) in discharge, as well as the output, frequency, and the like of discharge.

The power control portion 30 converts power of the main battery 10 or the auxiliary battery 20 and transfers the converted power to an energy receiving portion. The power control portion 30 converts the power of the main battery 10 or the auxiliary battery 20 to be compliant with a voltage used in the energy receiving portion. The power control portion 30 transfers power from the main battery 10 to the vehicle drive unit 50 or transfers power from the auxiliary battery 20 to the main battery 10. Furthermore, the power control portion 30 also supplies power from the main battery 10 to the electrical components 60.

The power control portion 30 may be implemented as a typical power converter. For example, the power control portion 30 is configured to integrally perform functions of an inverter converting power of the main battery 10 and transferring the converted power to the vehicle drive unit 50, a converter converting power of the auxiliary battery 20 and transferring the converted power to the main battery 10, and the like.

The controller 40 is configured to perform overall control over the battery control system according to an exemplary embodiment of the present disclosure. The controller 40 includes a first control module 41, a second control module 42, and a third control module 43. The controller 40 is configured to control charge, discharge, and the like of the main battery 10 and the auxiliary battery 20 using the first control module 41, the second control module 42, and the third control module 43.

The first control module 41 manages the state of the main battery 10 by obtaining information regarding overall state of the main battery 10. The first control module 41 obtains information regarding the temperature, SOC, and operating state of the main battery 10, transmits the information to the third control module 43, and receives information transmitted from the third control module 43. The operating state of the main battery 10 is classified into a charge state, a discharge state, and a non-operating state.

The second control module 42 manages the state of the auxiliary battery 20 by obtaining information regarding overall state of the auxiliary battery 20. The second control module 42 obtains information regarding the temperature, SOC, and operating state of the auxiliary battery 20 and transmits the information to the third control module 43. The operating state of the auxiliary battery 20 is classified into a charge state, a discharge state, and a non-operating state. The second control module 42 receives information transmitted from the third control module 43.

The third control module 43 is configured to perform overall control over the vehicle by obtaining information regarding overall state of the vehicle. The third control module 43 transmits driving state information, such as parking and stopping, of the vehicle to the first control module 41 and the second control module 42. Furthermore, the third control module 43 transfers state information, such as temperature and SOC, of the main battery 10 to the second control module 42.

The third control module 43 is configured to determine a charge condition of the main battery 10 and a discharge condition of the auxiliary battery 20 based on information received from the first control module 41 and the second control module 42, and transmits a discharge control signal to the second control module 42. The second control module 42 is configured to control the discharge condition of the auxiliary battery 20 according to the discharge control signal received from the third control module 43.

In driving of a vehicle, the controller 40 including these control modules 41, 42, and 43 is configured to perform a control operation of discharging the main battery 10 to supply the vehicle drive unit 50 with driving power and discharging the auxiliary battery 20 to charge the main battery 10.

Furthermore, the main battery 10 and the auxiliary battery 20 may be supplied with charging power from outside the vehicle through an internal charger of the vehicle. Here, the auxiliary battery 20 may be connected to the internal charger through the power control portion 30 or through the main battery 10 or the power control portion 30.

The controller 40 may manage the durability and stability of the auxiliary battery 20 by variably controlling discharge power of the auxiliary battery 20 based on the state information of the main battery 10 and the auxiliary battery 20 while driving of the vehicle.

To obtain the durability of the auxiliary battery 20, it is best to control the discharge rate of the auxiliary battery 20 to be the same as a discharge rate at which the main battery 10 discharges power to the vehicle drive unit 50 while driving of the vehicle. However, to control the discharge rate of the auxiliary battery 20 to be the same as the discharge rate of the main battery 10, the power control portion 30 is required to be driven to continuously convert discharge power of the auxiliary battery 20 while driving of the vehicle. Thus, it is impossible in terms of efficiency to control the discharge rate of the auxiliary battery 20 to be the same as the discharge rate of the main battery 10.

Accordingly, when the charge condition of the main battery 10 and the discharge condition of the auxiliary battery 20 are met, the controller 40 charges the main battery 10 by controlling discharge power of the auxiliary battery 20 at a discharge rate higher than the discharge rate of the main battery 10.

Here, when the main battery 10 reaches a predetermined SOC (i.e., a first SOC), the controller 40 discharges the auxiliary battery 20 to the predetermined SOC (i.e., the first SOC) to minimize the difference between the number of charge/discharge cycles of the auxiliary battery 20 and the difference between the number of charge/discharge cycles of the main battery 10. For example, the first SOC may be determined to be 50%.

Furthermore, when the auxiliary battery 20 is neglected without being operated for an extended time, the controller 40 may discharge the auxiliary battery 20 to the first SOC depending on the non-operating time and temperature of the auxiliary battery 20.

The discharge power of the auxiliary battery 20 is determined based on the temperature and SOC value of the auxiliary battery 20, and according to a battery output map stored in the controller 40. The battery output map is previously configured to determine discharge power of the auxiliary battery 20 according to the temperature and SOC value of the auxiliary battery 20 and stored in a memory of the controller 40.

Here, the first SOC is derived and determined to be an SOC value at which the main battery 10 is efficiently charged and an SOC range and the frequency of discharge of the auxiliary battery 20 are optimized.

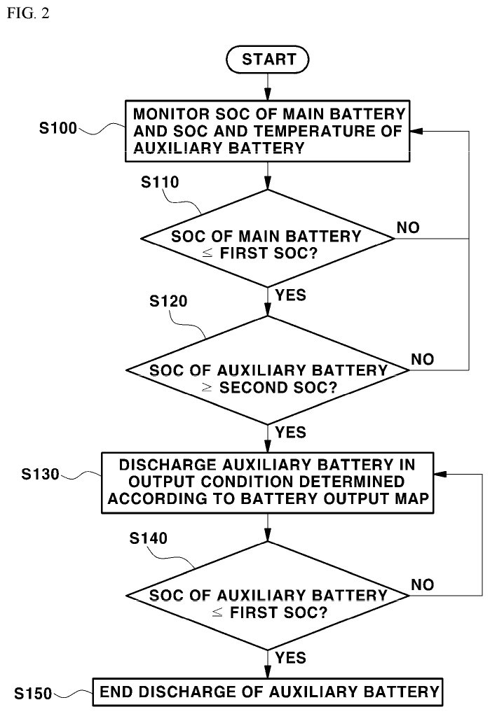

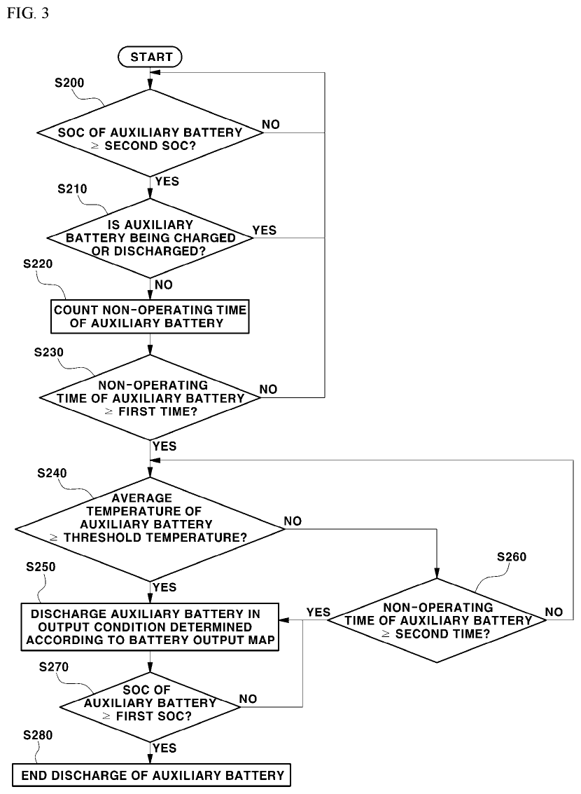

In the accompanying drawings, FIG. 2 is a flowchart illustrating a method of controlling discharge of an auxiliary battery while driving according to various exemplary embodiments of the present disclosure, and FIG. 3 is a flowchart illustrating a method of controlling discharge of an auxiliary battery when the auxiliary battery is not working according to various exemplary embodiments of the present disclosure.

Hereinafter, with reference to FIG. 2 and FIG. 3, the method of controlling discharge of an auxiliary battery will be described in more detail. The following method of controlling the discharge of the auxiliary battery 20 will be carried out by the controller 40.

As illustrated in FIG. 2, the SOC of the main battery 10 and the SOC value and the temperature of the auxiliary battery 20 are monitored while driving of a vehicle in S100. A case in which the vehicle speed is zero (0) is included in a case in which the vehicle is driving.

Afterwards, the monitored SOC value of the main battery 10 is compared with the first SOC in S110. The SOC value of the main battery 10 may gradually decrease during the driving to reach a predetermined first SOC. When the SOC value of the main battery 10 reaches and then is equal to or lower than the first SOC value, a condition for the auxiliary battery 20 to be discharged (i.e., a discharge condition of the auxiliary battery 20) is determined to be met.

The discharge condition of the auxiliary battery 20 is the SOC value of the auxiliary battery 20. That is, whether or not to discharge the auxiliary battery 20 is determined based on real-time SOC value of the auxiliary battery 20. Thus, when the SOC value of the main battery 10 is equal to or lower than the first SOC value, the SOC value of the auxiliary battery 20 is compared with a predetermined second SOC in S120. When the SOC value of the main battery 10 is higher than a predetermined third SOC value and is equal to or lower than the first SOC value, the SOC value of the auxiliary battery 20 is compared with the second SOC. The second SOC is determined to be an SOC value higher than the first SOC value, and the third SOC is determined to be an SOC value lower than the first SOC value. For example, the second SOC may be determined to be 10%, while the third SOC may be determined to be 60%.

When the SOC value of the SOC value of the main battery 10 is higher than the first SOC value, the auxiliary battery 20 is not discharged irrespective of the SOC value of the auxiliary battery 20.

When the SOC value of the main battery 10 is higher than the third SOC value and is equal to or lower than the first SOC value, when the SOC value of the auxiliary battery 20 is equal to or greater than the second SOC value, the auxiliary battery 20 is discharged in S130. Furthermore, even in a case in which the SOC value of the main battery 10 is higher than the third SOC value and is equal to or lower than the first SOC value, when the SOC value of the auxiliary battery 20 is lower than the second SOC value, the auxiliary battery 20 is not discharged. When the auxiliary battery 20 is not discharged, at least one of the main battery 10 and the auxiliary battery 20 may be charged using external power supplied from outside the vehicle.

When discharging the auxiliary battery 20, the discharge of the auxiliary battery 20 is controlled in a condition (i.e., a discharge power value) determined according to the first battery output map. The first battery output map determines discharge power of the auxiliary battery 20 depending on the temperature and SOC value of the auxiliary battery 20.

While the auxiliary battery 20 is being discharged, the SOC value of the auxiliary battery 20 is compared with the first SOC in S140. When the SOC value of the auxiliary battery 20 decreases due to the discharge of the auxiliary battery 20 to reach the first SOC value, the discharge of the auxiliary battery 20 is ended in S150.

Here, when non-discharge state of the auxiliary battery 20 is maintained for an extended time, the second SOC is determined to be a value at which the auxiliary battery 20 may be caused to swell or be subjected to a decrease in durability. The third SOC is determined to be a value at which the main battery 10 is required to be charged irrespective of the SOC or temperature of the auxiliary battery 20. In other words, the third SOC is determined to be an SOC value at which it is forced to charge the main battery 10 to obtain driving safety of the vehicle.

Furthermore, when the SOC value of the main battery 10 is equal to or lower than the third SOC value, the main battery 10 is charged to the maximum level as possible by discharging the auxiliary battery 20 irrespective of an SOC value of the auxiliary battery 20 to obtain driving safety of the vehicle. Here, the auxiliary battery 20 may supply power to the main battery 10 until auxiliary battery 20 is completely discharged. That is, when the SOC value of the main battery 10 is equal to or lower than the third SOC value, the auxiliary battery 20 may be discharged until the SOC value of the auxiliary battery 20 reaches 0%. Furthermore, at the instant time, discharge power of the auxiliary battery 20 may be controlled in a condition determined according to a second battery output map.

As described above, the discharge of the auxiliary battery 20 may be controlled while driving of the vehicle to optimize the SOC range the SOC range in which the second battery is discharged and the frequency of discharge of the auxiliary battery 20. Consequently, the durability of the auxiliary battery 20 may be obtained, preventing the lifetime of the auxiliary battery 20 from decreasing.

Furthermore, when the auxiliary battery 20 has not been operated for an extended time, the durability of the auxiliary battery 20 may be reduced. Accordingly, the controller 40 is configured to control the discharge operation of the auxiliary battery 20 based on non-operating time and temperature of the auxiliary battery 20. Furthermore, the controller 40 may monitor the SOC value of the main battery 10 and the SOC value and the temperature of the auxiliary battery 20 and control the discharge operation and the like of the auxiliary battery 20 even when the vehicle is turned off.

As illustrated in FIG. 3, the SOC value of the auxiliary battery 20 is monitored first, and then, the monitored SOC value of the auxiliary battery 20 is compared with the second SOC in S200. When the SOC value of the auxiliary battery 20 is equal to or greater than the second SOC value, whether or not the auxiliary battery 20 is being discharged or the auxiliary battery 20 is being charged is reviewed in S210. When the auxiliary battery 20 is being nether discharged nor charged, the non-operating time of the auxiliary battery 20 is counted in S220. When the auxiliary battery 20 is being nether discharged nor charged, the auxiliary battery 20 is determined to not be operating.

For example, the controller 40 may include a counter counting the non-operating time of the auxiliary battery 20. In another example, the controller 40 may count the non-operating time of the auxiliary battery 20 using a separately-provided external counter. The counter counts a time during which the auxiliary battery 20 has not operated continuously. When the auxiliary battery 20 is charged or discharged while the non-operating time of the auxiliary battery 20 is being counted, the counter initializes the counted non-operating time of the auxiliary battery 20 to zero (0).

The non-operating time of the auxiliary battery 20 counted in S220 is compared with a predetermined first time in S230. When the non-operating time of the auxiliary battery 20 is smaller than the first time, the non-operating time of the auxiliary battery 20 is counted continuously. When the non-operating time of the auxiliary battery 20 reaches the first time and is equal to or greater than the first time, an average temperature of the auxiliary battery 20 is compared with a predetermined threshold temperature in S240.

When the SOC value of the auxiliary battery 20 is higher than the second SOC value and the average temperature of the auxiliary battery 20 is equal to or greater than the threshold temperature, when the auxiliary battery 20 is not discharged, the first time is determined to be a time value in which a decrease in the lifetime of the auxiliary battery 20 is caused due to the swelling and deterioration thereof. For example, the first time may be determined to be 168 hours.

The average temperature of the auxiliary battery 20 is an average temperature during the non-operating time of the auxiliary battery 20. The threshold temperature is determined to be a temperature value at which deterioration and decreases in the durability of the auxiliary battery 20 may be caused with increases in time during which the auxiliary battery 20 is not operated and not used. For example, the threshold temperature may be determined to be 35° C.

As a result of S240, when the average temperature of the auxiliary battery 20 is equal to or greater than the threshold temperature, the auxiliary battery 20 is discharged intentionally in S250. Here, the discharge power of the auxiliary battery 20 is determined to be and is controlled as an output value determined according to a third battery output map.

Furthermore, when the average temperature of the auxiliary battery 20 is lower than the threshold temperature, the non-operating time of the auxiliary battery 20 is counted continuously and is compared with a predetermined second time in S260. When the SOC value of the auxiliary battery 20 is higher than the second SOC value, when the auxiliary battery 20 is not discharged even in the case that the average temperature of the auxiliary battery 20 is lower than the threshold temperature, the second time is determined to be a time value in which a decrease in the lifetime of the auxiliary battery 20 is caused due to the swelling and deterioration thereof. For example, the second time may be determined to be three months.

When the non-operating time of the auxiliary battery 20 reaches the second time and is equal to or greater than the second time, the auxiliary battery 20 is discharged intentionally in S250. Here, the discharge power of the auxiliary battery 20 is determined to be and controlled as an output value determined according to a fourth battery output map.

Here, all of the first to fourth battery output maps are configured to determine the discharge power of the auxiliary battery 20 based on the SOC value and the temperature of the auxiliary battery 20. Here, the third and fourth battery output maps may be configured to determine different discharge power values for the same SOC value and temperature condition of the auxiliary battery 20. Furthermore, the first battery output map may be configured to determine a discharge power value a same as that of the fourth battery output map for the same SOC value and temperature condition of the auxiliary battery 20.

Furthermore, while the auxiliary battery 20 is being discharged after whether or not to discharge the auxiliary battery 20 is determined according to the non-operating time and the average temperature of the auxiliary battery 20 as described above, the SOC value of the auxiliary battery 20 is compared with the first SOC in S270. When the SOC value of the auxiliary battery 20 is reduced to reach the first SOC value, the operation of discharging the auxiliary battery 20 is ended in S280.

As set forth above, when the auxiliary battery 20 has not operated for an extended time, the auxiliary battery 20 may be discharged intentionally according to the state of the auxiliary battery 20 to prevent the auxiliary battery 20 from swelling and a decrease in durability, which would otherwise be caused due to non-use of the auxiliary battery 20. Furthermore, it is possible to prevent a reduction in the lifetime of the auxiliary battery 20 due to the swelling or decrease in durability and obtain the stability of the auxiliary battery 20.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling discharge of a battery in a vehicle that generates driving power using electric power, the method comprising:
monitoring, by a controller, a state of charge (SOC) value of a first battery configured to supply the electric power to a driving unit of the vehicle and an SOC value and a temperature of a second battery configured to charge the first battery;
discharging, by the controller, the second battery and charging the first battery by discharging the second battery when the controller concludes that the SOC value of the first battery reaches a predetermined first SOC value; and
ending, by the controller, the discharging of the second battery when the controller concludes that the SOC value of the second battery reaches the first SOC value.

2. The method of claim 1, wherein when the SOC value of the first battery is higher than the first SOC value, the second battery is not discharged.

3. The method of claim 1, wherein when the SOC value of the first battery is equal to or lower than the first SOC value and the SOC value of the second battery is equal to or greater than a second SOC value determined to be higher than the first SOC value, the second battery is discharged.

4. The method of claim 3, wherein when the SOC value of the first battery is equal to or lower than the first SOC value and the SOC value of the second battery is lower than the second SOC value, the second battery is not discharged.

5. The method of claim 4, wherein when the SOC value of the first battery is equal to or lower than a third SOC value determined to be lower than the first SOC value, the first battery is charged by discharging the second battery irrespective of the SOC value of the second battery.

6. The method of claim 1, wherein the discharging of the second battery is performed in an output condition determined according to the SOC value and the temperature of the second battery.

7. The method of claim 1, further including:
counting, by the controller, a non-operating time in which the second battery is nether discharged nor charged when the SOC value of the second battery is equal to or greater than a second SOC value and the second battery is nether discharged nor charged; and
determining, by the controller, whether to discharge the second battery according to the non-operating time of the second battery and an average temperature of the second battery during the non-operating time.

8. The method of claim 7, wherein when the non-operating time of the second battery is equal to or greater than a predetermined first time and the average temperature of the second battery is equal to or greater than a predetermined threshold temperature, the second battery is discharged until the SOC value of the second battery reaches the first SOC value.

9. The method of claim 8, wherein the second battery is discharged in an output condition determined according to the SOC value and the temperature of the second battery.

10. The method of claim 8, wherein when the non-operating time of the second battery is equal to or greater than a second time determined to be greater than the first time, the second battery is discharged until the SOC value of the second battery reaches the first SOC value irrespective of the average temperature of the second battery.

11. The method of claim 10, wherein the second battery is discharged in an output condition determined according to the SOC value and the temperature of the second battery.

12. An apparatus of controlling discharge of a battery in a vehicle that generates driving power using electric power, the apparatus comprising:
a first battery and a second battery; and
a controller including a processor and electrically connected to the first battery and the second battery and configured for:
monitoring a state of charge (SOC) value of the first battery configured to supply the electric power to a driving unit of the vehicle and an SOC value and a temperature of the second battery configured to charge the first battery;
discharging the second battery and charging the first battery by discharging the second battery when the controller concludes that the SOC value of the first battery reaches a predetermined first SOC value; and
ending the discharging of the second battery when the controller concludes that the SOC value of the second battery reaches the first SOC value.

13. The apparatus of claim 12, wherein when the SOC value of the first battery is higher than the first SOC value, the second battery is not discharged.

14. The apparatus of claim 12, wherein when the SOC value of the first battery is equal to or lower than the first SOC value and the SOC value of the second battery is equal to or greater than a second SOC value determined to be higher than the first SOC value, the second battery is discharged.

15. The apparatus of claim 14, wherein when the SOC value of the first battery is equal to or lower than the first SOC value and the SOC value of the second battery is lower than the second SOC value, the second battery is not discharged.

16. The apparatus of claim 15, wherein when the SOC value of the first battery is equal to or lower than a third SOC value determined to be lower than the first SOC value, the first battery is charged by discharging the second battery irrespective of the SOC value of the second battery.

17. The apparatus of claim 12, wherein the controller is further configured for:
counting a non-operating time in which the second battery is nether discharged nor charged when the SOC value of the second battery is equal to or greater than a second SOC value and the second battery is nether discharged nor charged; and
determining whether to discharge the second battery according to the non-operating time of the second battery and an average temperature of the second battery during the non-operating time.

18. The apparatus of claim 17, wherein when the non-operating time of the second battery is equal to or greater than a predetermined first time and the average temperature of the second battery is equal to or greater than a predetermined threshold temperature, the second battery is discharged until the SOC value of the second battery reaches the first SOC value.

19. The apparatus of claim 18, wherein when the non-operating time of the second battery is equal to or greater than a second time determined to be greater than the first time, the second battery is discharged until the SOC value of the second battery reaches the first SOC value irrespective of the average temperature of the second battery.
